(19) United States
(12) Patent Application Publication
(10) Pub. No.: US 2026/0290372 A1
(43) Pub. Date: Sep. 24, 2026

(54) SYSTEM AND METHOD FOR PROMPTING AUDIO GENERATIONS TO IMPROVE AUDIO FOUNDATION MODELS

(71) Applicant: Robert Bosch GmbH, Stuttgart (DE)

(72) Inventors: Ho-Hsiang WU, Morrisville, NC (US); Francesca RONCHINI, Viterbo (IT); Wei-Cheng LIN, Pittsburgh, PA (US)

(21) Appl. No.: 19/088,775

(22) Filed: Mar. 24, 2025

(51) Int. Cl. G10L 25/51; G06F 40/40

(52) U.S. Cl. CPC G10L 25/51; G06F 40/40

(57) ABSTRACT

Systems and methods for generating audio samples for training and data augmentation in audio classification and contrastive language-audio pretraining are disclosed. A large language model applies a prompting strategy to generate textual descriptions for a sound catalog. The prompting strategy may use sound class descriptors, structured descriptions incorporating sound attributes such as pitch and intensity, or exemplar-based descriptions derived from human-annotated datasets. A pre-trained audio generative model synthesizes audio samples based on the generated textual descriptions. The synthesized audio samples are then used to train an audio foundational model, such as an audio classification model or a contrastive language-audio pretraining model.

### TECHNICAL FIELD

Aspects of the disclosure generally relate to generating synthetic audio datasets using text-to-audio models to improve audio foundation models for classification and pretraining tasks.

### BACKGROUND

Machine learning models for audio processing rely on large, high-quality labeled datasets for training. However, obtaining such datasets presents challenges, including privacy concerns, limited availability, and the time-consuming nature of manual annotation.

### SUMMARY

In one aspect of the disclosure, a method for generating audio samples for a text-to-audio generative model is presented. The method includes capturing sounds from a real-world environment using a sensor to construct a sound catalog, using a prompting strategy with a large language model to generate textual descriptions based on the sound catalog, and applying a pre-trained audio generative model to synthesize audio samples based on the textual descriptions. The method further includes training an audio foundational model using the outputted synthesized audio samples.

The method may include generating the textual descriptions within the sound catalog using a sound class descriptor that characterizes audio content based on its acoustic properties or semantic meaning.

The method may include identifying sound attributes and generating textual descriptions within the sound catalog incorporating identified sound attributes.

The method may include defining sound attributes as one or more of pitch, pattern, intensity, acoustic characteristics, and location.

The method may include selecting human-annotated captions from an existing dataset and using the selected captions as examples for generating additional textual descriptions within the sound catalog.

The method may include modifying hyperparameters of the pre-trained audio generative model.

The method may include defining hyperparameters as one or more of temperature, top-k sampling, top-p sampling, conditioning strength, and noise scale.

The method may include training a sound classification model using the synthesized audio samples and real-world collected audio data.

In another aspect of the disclosure, a system for generating audio samples for training and data augmentation in audio classification and contrastive language-audio pre-training is presented. The system includes a sensor configured to capture real-world audio signals for inclusion in a sound catalog, a memory configured to store audio datasets and generated captions, and a processor configured to use a few-shot methodology with a large language model to apply a prompting strategy and generate a library of audio clip descriptions, apply a pre-trained audio generative model to synthesize audio samples based on the generated audio clip descriptions, and output an audio foundational model trained using synthesized audio samples.

The system may include the prompting strategy being a basic prompt strategy that generates audio clip descriptions using a sound class descriptor that characterizes audio content based on its acoustic properties or semantic meaning.

The system may include the prompting strategy being a structured prompting strategy that includes identifying sound attributes and generating the library of audio clip descriptions by incorporating identified attributes.

The system may include the prompting strategy being an exemplar-based prompting strategy that includes selecting human-annotated captions from an existing library of audio clip descriptions and using the selected audio clip descriptions as examples for generating additional audio clip descriptions.

The system may include the processor generating the output synthesized audio samples by using multiple prompting strategies.

The system may include the processor synthesizing audio samples by combining audio samples from multiple audio-generative models.

In yet another aspect of the disclosure, a non-transitory computer-readable medium storing instructions is presented. The instructions, when executed by one or more hardware computing devices, cause the one or more hardware computing devices to perform operations including capturing real-world sounds using one or more sensors to populate a text-based sound catalog, using a few-shot prompting strategy with a large language model to generate descriptions of the captured sounds, applying a pre-trained audio generative model to synthesize audio samples based on the text-based sound catalog, and outputting an optimized audio foundational model trained using synthesized audio samples.

The non-transitory computer-readable medium may include the few-shot prompting strategy generating the text-based sound catalog using a sound class descriptor that characterizes audio content based on its acoustic properties or semantic meaning.

The non-transitory computer-readable medium may include the few-shot prompting strategy identifying sound attributes and generating the text-based sound catalog by incorporating identified attributes.

The non-transitory computer-readable medium may include defining sound attributes as one or more of pitch, pattern, intensity, acoustic characteristics, and location.

The non-transitory computer-readable medium may include the few-shot prompting strategy selecting human-annotated captions from an existing text-based sound catalog and using the selected captions as examples for generating additional entries to the existing text-based sound catalog.

The non-transitory computer-readable medium may include the pre-trained audio generative model being an autoregressive model or a latent diffusion model.

### BRIEF DESCRIPTION OF THE DRAWINGS

FIG. 1 is a block diagram of a system for generating and classifying audio samples using prompting strategies;

FIG. 2 is a flowchart of a method for generating and using synthetic audio samples to train an audio classification model;

FIGS. 3A and 3B are graphs showing the accuracy of a convolutional neural network trained with synthetic datasets generated using test-time adaptation models;

FIGS. 4A and 4B are graphs comparing classification accuracy when synthetic data is used for augmentation;

FIG. 5 illustrates an example computing device for generating, classifying, and training audio datasets; and

FIG. 6 illustrates an example manufacturing system implementing the framework for use in anomaly detection.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present embodiments. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Text-to-audio (TTA) generative models offer promise for producing synthetic audio samples from textual prompts. TTA models have been explored for various applications, such as speech synthesis and environmental sound classification. However, their effectiveness in generating diverse and realistic datasets remains limited due to simplistic prompting approaches. Basic prompts often unsuccessful in capturing the complexity of real-world audio, limiting the usefulness of generated samples for training audio classification models and contrastive language-audio pretraining (CLAP) models.

Aspects of the disclosure relate to an improved approach for generating synthetic audio datasets utilizing TTA models for training sound classification (SC) models. The disclosed approach involves employing structured and exemplar-based prompt strategies to increase the diversity and accuracy of generated datasets. Additionally, the disclosure outlines techniques for merging datasets from different TTA models to optimize SC model performance. By implementing these strategies, synthetic audio may be effectively leveraged to improve SC applications and address limitations in dataset availability.

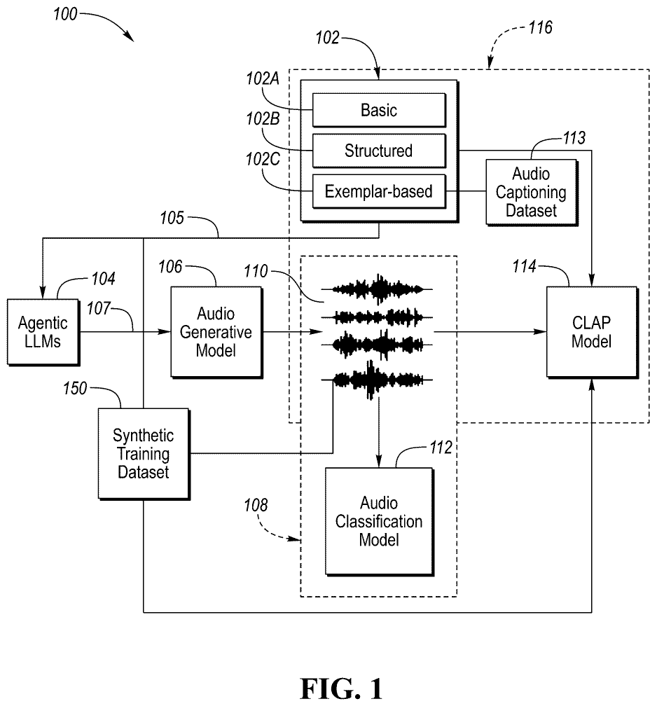

FIG. 1 illustrates a system 100 for generating audio samples using different prompting strategies in conjunction with an audio generative model 106. The system 100 includes an agentic large language model (LLM) 104, an audio generative model 106, an audio classification model 112, a CLAP model 114. A set of prompting strategies 102 is utilized to generate LLM prompts 105. These LLM prompts 105 are provided to the agentic LLM 104 to generate audio prompts 107. The audio prompts 107 are provided to the audio generative model 106 to generate audio samples 110. The audio samples 110 are classified by the audio classification model 112. The audio samples 110 in combination with the LLM prompts 105 may be formed into a synthetic training dataset 150. The synthetic training dataset 150 may be used to train and/or finetune the CLAP model 114 for various tasks.

The agentic large language model (LLM) 104 may be any of various large language models (LLM) that are trained to autonomously perform complex tasks by reasoning, planning, and making decisions based on user input and contextual understanding. As some non-limiting examples, the agentic LLM 104 may include an OpenAI GPT model, an Anthropic Claude model, a Google Gemini models, or a Meta LLAMA model.

The audio generative model 106 may be any of various TTA models. TTA models refer to deep learning frameworks designed to synthesize audio from textual prompts. As some non-limiting examples, the audio generative model 106 may be any of various pre-trained TTA models, two of which are: AudioGen (AG) and Stable Audio Open (SA). AG is an autoregressive model that encodes raw audio into a discrete representation and generates sequences conditioned on text input. SA is a latent diffusion model that utilizes a transformer-based architecture to generate variable-length stereo audio.

The audio classification model 112 refers to a machine learning system designed to analyze and categorize audio signals into predefined classes based on their characteristics. The audio classification model 112 may process audio waveforms or spectrogram representations to recognize patterns such as speech, music, environmental sounds, or specific keywords. Audio classification model 112 may be used for applications such as voice recognition, music genre classification, emotion detection, and anomaly detection in industrial settings. The audio classification model 112 may be implemented using various deep learning architectures, such as convolutional neural networks (CNNs) or recurrent neural networks (RNNs), to extract meaningful features and improve classification accuracy.

The CLAP model 114 refers to a ML model designed to learn associations between audio and natural language descriptions using contrastive learning techniques. The CLAP model 114 may be trained on paired audio-text datasets, enabling the CLAP model 114 to understand and generate meaningful representations of sounds in relation to textual descriptions. Similar to models like CLIP for vision-language tasks, CLAP aligns audio embeddings with corresponding text embeddings in a shared latent space, allowing for applications such as zero-shot audio classification, sound retrieval using natural language queries, and cross-modal understanding. The CLAP model 114 may be useful for audio analysis, music information retrieval, and accessibility technologies.

The prompting strategies 102 refer to different approaches for generating the audio prompts 107 to be provided to the audio generative model 106. The prompting strategies 102 may include a basic prompt strategy (BSC) 102A, structured prompt strategy (STR) 102B, and an exemplar-based prompt strategy (EXE) 102C. The basic prompt strategy 102A is a one-step process by which the audio prompts 107 are generated programmatically, without the use of the LLM 104. The structured prompt strategy 102B and an exemplar-based prompt strategy 102C are two-step processes whereby LLM prompts 105 are generated to be provided to the agentic LLM 104, which, in turn produces the audio prompts 107 to instruct the audio generative model 106. To optimize the quality of the generated datasets, multiple prompting strategies 102 may be employed.

The basic prompt strategy 102A utilizes a simple and predefined text format to directly instruct the audio generative model 106. The prompts are structured as “The sound of a <sound class>”, where <sound class> is dynamically replaced with a category from a predefined dataset 111. Under the basic prompt strategy 102A, the agentic LLM 104 is not used. The basic prompt strategy 102A accordingly provides a straightforward and automated method for generating sound descriptions. However, this approach may lack the richness necessary for complex audio synthesis.

The structured prompt strategy 102B uses the large language model 104 to generate descriptive audio prompts 107 that incorporate various sound attributes. First, the agentic large language model 104 is instructed to identify key sound attributes for use in creating detailed sound descriptions. These key attributes may include, as some non-limiting examples, pitch, pattern, intensity, acoustic characteristics, and location. Next, the agentic large language model 104 is used to incorporate these attributes into natural language sentences, creating detailed and semantically rich prompts. For instance, a generated audio prompt 107 may be, “The quick, high-pitched screech of a chainsaw making short, sharp cuts in softwood.” The structured prompt strategy 102B increases audio diversity and improves precision by confirming that the generated audio prompts 107 include relevant and descriptive elements. The structured prompt strategy 102B is designed to enrich textual descriptions in a controlled manner, significantly enhancing audio diversity compared to the basic prompt strategy 102A.

The exemplar-based prompt strategy 102C utilizes human-annotated captions from existing datasets to guide generation of the audio prompts 107. In an example, an audio captioning dataset 113 (such as Clotho) may be used, which contains audio clips paired with multiple human-generated captions. This approach is motivated by a desire to capture the richness and contextual relevance of human-generated descriptions. By using these annotations as guidance for creating the audio prompts 107, the system 100 ensures that the generated sentences are both high-quality and relevant, enhancing the diversity and accuracy of audio representations in the resulting dataset. Thus, the system 100 can confirm that generated audio prompts 107 reflect natural language descriptions, maintaining contextual relevance and high quality. The agentic LLM 104 uses these exemplars from the audio captioning dataset 113 as reference points to generate new audio prompts 107 with improved linguistic and contextual fidelity.

The audio generative model 106 synthesizes audio samples 110 based on the audio prompts 107. By changing the hyperparameters of the audio generative model 106, such as temperature, a diverse set of audio samples 110 may be generated. For consistency, if multiple models are used to synthesize the audio samples 110, the generated outputs of the audio generative models 106 may be resampled into a common format. For example, because SA is stereo, the samples may be converted to mono if SA is used in combination with AG which produces single channel output. In another example, the audio clips may be resampled to a common sampling rate, such as 16 kHz.

The generated audio samples 110 may be subsequently used in various pathways. As part of the audio classification framework 108 they may be fed into the audio classification model 112 as training data, allowing for increased sound classification training performance of the audio classification model 112. For example, the category output of the audio classification model 112 may be compared to the key attributes, categories, and/or audio prompts 107 as ground truth for training or fine-tuning of the audio classification model 112.

In another example, as part of the data generation and augmentation framework 116, the generated audio samples 110 may be utilized along with their associated audio prompts 107 produced by the prompting strategies 102, as training data for the CLAP model 114. The CLAP model 114 enables increased alignment between text and audio representations, further increasing the capability of the system 100 for sound recognition and classification.

Using the provided prompt strategies 102, a comprehensive collection of audio prompts 107 may be produced. In contrast to the basic prompt strategy 102A, which allows for simple automated generation, the structured prompt strategy 102B and the exemplar-based prompt strategy 102C may utilize a more nuanced approach. For instance, a few-shot methodology may be utilized by providing the LLM 104 with a limited set of randomly selected example audio prompts 107 for each strategy 102, ensuring that each audio file in the considered datasets receives a unique prompt caption. For the structured prompt strategy 102B, these examples may consist of sentences generated by the LLM 104.

For the exemplar-based prompt strategy 102C, these examples may be selected from the audio captioning dataset 113. To create an entire collection of audio prompts 107, the LLM 104 may be instructed to use the examples from the audio captioning dataset 113 as a foundation for generating new captions for the audio files. This process may include providing the LLM 104 with detailed instructions to ensure it generates varied and original captions that emphasize creativity and diversity, while also being well-structured and relevant to their respective sound classes.

The disclosed system 100 may be deployed in real-world applications where synthetic audio data enhances machine learning model training and classification accuracy. For example, in automotive diagnostics, synthetic audio samples generated using structured and exemplar-based prompting strategies may be used to train SC models to recognize abnormal engine noises, enabling predictive maintenance in modern vehicles. Similarly, in wildlife conservation, synthetic datasets may be used to augment bioacoustic monitoring models, helping researchers classify animal calls in environments where collecting real-world data is challenging. Additionally, accessibility applications may benefit from synthetic audio datasets used to train assistive devices that classify important environmental sounds, such as alarms, doorbells, or approaching vehicles, for individuals with hearing impairments. By generating and classifying high-quality synthetic audio, system 100 may increase the adaptability of SC models across diverse industries.

The generated dataset of audio samples 110 may be evaluated in various ways. For example, the audio samples 110 may be evaluated using a CNN10 model, which is a convolutional neural network from the Pretrained Audio Neural Networks (PANNs) collection trained from scratch with synthetic and real datasets. The CNN10 model is designed for audio classification tasks, particularly for analyzing and recognizing sound events in environmental audio recordings. CNN10 processes mel spectrograms or other time-frequency representations of audio signals, extracting relevant features through multiple convolutional layers. The CNN10 model is often pretrained on large-scale datasets such as AudioSet, making it useful for transfer learning in various audio-based applications. As an approach to evaluation, the generated dataset of audio samples 110 may be used in the training of the CNN10 model.

To do so, synthetic datasets may be generated to replicate two benchmark SC datasets. The ESC50 Dataset includes 2,000 labeled environmental audio recordings across 50 sound classes. The UrbanSound8k (US8K) Dataset includes 8,732 labeled urban sound recordings distributed among 10 classes. Each dataset may be synthetically reproduced using the three prompt strategies 102 while maintaining dataset distributions consistent with the original sources.

The SC model used for evaluation is CNN10, trained from scratch for up to 200 epochs with early stopping based on validation loss. The evaluation methodology includes five-fold cross-validation for ESC50 and ten-fold cross-validation for US8K. Accuracy serves as the primary performance metric. The baseline for comparison is the CNN10 model trained exclusively on the original dataset without synthetic augmentation.

Experimental results reveal that structured and exemplar-based prompt strategies significantly outperform the BSC approach in terms of classification accuracy (see Table I). This improvement stems from increased textual richness, which leads to increased diversity in synthetic audio outputs.

TABLE I
Comparison between different prompt strategies used
to generate the synthetic dataset to replace the
real dataset. The metric reported is accuracy.

| | |
|---|---|
| ESC50 | US8K |

| Prompt | Stable | | Stable | |
|---|---|---|---|---|
| technique | Audio | AudioGen | Audio | AudioGen |
| BSC | 0.34 | 0.30 | 0.39 | 0.42 |
| STR | 0.40 | 0.26 | 0.56 | 0.45 |
| EXE | 0.41 | 0.31 | 0.51 | 0.47 |

| | | |
|---|---|---|
| Baseline | 0.67 | 0.78 |

When used as a data augmentation technique alongside real datasets, structured and exemplar-based strategies yield better performance gains compared to the BSC (see Table II). However, the effectiveness varies across datasets, with ESC50 benefiting more than US8K due to differences in dataset complexity. Increasing the number of synthetic samples per category narrows the performance gap between real and synthetic datasets, but dataset distribution mismatches and class confusion persist, particularly for similar sound categories such as sheep and cows or helicopter and airplane sounds.

TABLE II
Comparison between different prompt strategies when
generated datasets are used as data augmentation
technique. The metric reported is accuracy.

| | |
|---|---|
| ESC50 | US8K |

| Prompt | Stable | | Stable | |
|---|---|---|---|---|
| technique | Audio | AudioGen | Audio | AudioGen |
| BSC w/ORG | 0.70 | 0.67 | 0.77 | 0.78 |
| STR w/ORG | 0.72 | 0.67 | 0.79 | 0.78 |
| EXE w/ORG | 0.69 | 0.68 | 0.79 | 0.78 |

| | | |
|---|---|---|
| Baseline | 0.67 | 0.78 |

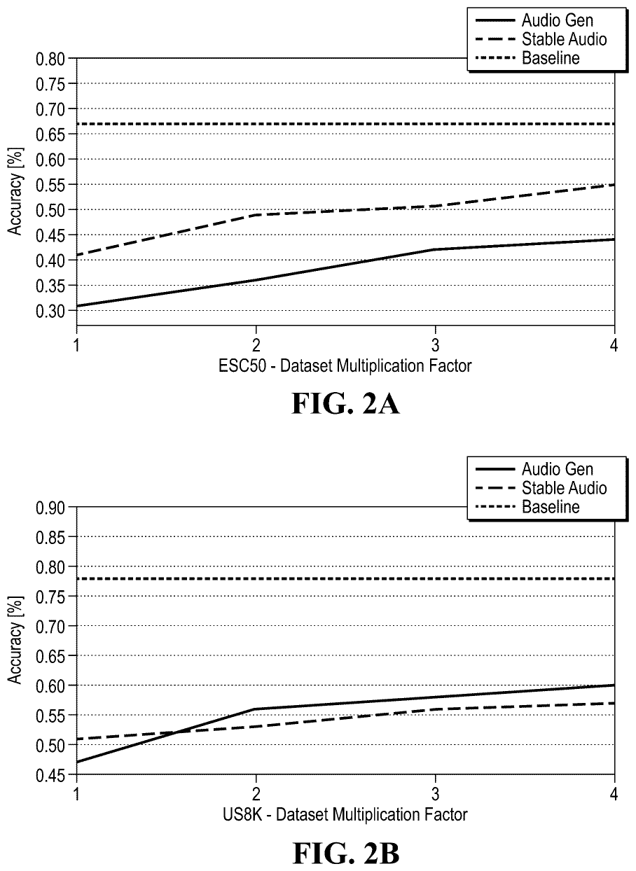

FIGS. 2A and 2B show the accuracy of CNN10 when trained with synthetic datasets generated using TTA models. In both datasets, increasing the number of synthetic training samples increases classification accuracy, though the degree of improvement varies across datasets. The results indicate that while synthetic data alone does not fully match the performance of real datasets, it provides a useful augmentation technique to increase the capabilities of SC models. The performance gap is more evident in ESC50 than in US8K, this may indicate dataset-specific effects in the efficacy of synthetic data generation.

To further increase classification accuracy, datasets generated using different prompt strategies are merged. Results indicate that combining two different prompt strategies yields greater SC model improvements than merely increasing dataset size using a single strategy (see Table III). This finding highlights the role of prompt diversity in increasing the quality of synthetic training data.

TABLE III
Accuracy of CNN10 when trained with merged datasets
generated from different prompt techniques.

| | ESC50 | | US8K | |
|---|---|---|---|---|
| Prompt | Stable | | Stable | |
| technique | Audio | AudioGen | Audio | AudioGen |
| BSC, EXE | 0.48 | 0.40 | 0.50 | 0.51 |
| BSC, STR | 0.46 | 0.38 | 0.53 | 0.56 |
| EXE, STR | 0.48 | 0.36 | 0.57 | 0.55 |
| BSC, EXE, STR | 0.55 | 0.42 | 0.55 | 0.60 |
| BSC, EXE, STR | 0.75 | 0.76 | 0.78 | 0.79 |
| w/ORG | | | | |

| | | |
|---|---|---|
| Baseline | 0.67 | 0.78 |

Furthermore, merging datasets generated by different TTA models (AG and SA) results in further accuracy improvements compared to merely increasing the dataset size from a single TTA model (see Table IV). This suggests that different TTA models capture complementary aspects of sound generation, leading to increased SC model performance when combined.

TABLE IV
Accuracy of CNN10 when trained on merged datasets generated
using the same prompt technique across different TTA models.

| Prompt tech. | ESC50 (SA + AG) | US8K (SA + AG) |
|---|---|---|
| EXE | 0.52 | 0.60 |
| STR | 0.49 | 0.61 |
| EXE w/ORG | 0.75 | 0.79 |
| STR w/ORG | 0.75 | 0.80 |
| Baseline | 0.67 | 0.78 |

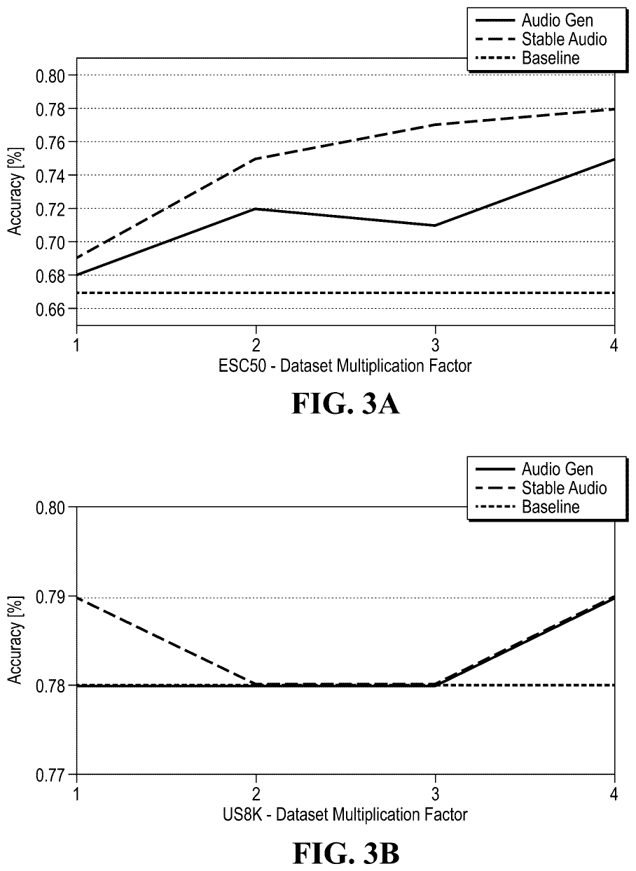

FIGS. 3A and 3B show the accuracy results when synthetic datasets are used as a data augmentation technique alongside real datasets. The results confirm that adding synthetic data to real datasets increases SC model performance beyond training on real data alone. Additionally, using diverse prompt strategies further increases accuracy, reinforcing the advantage of generating varied synthetic samples. Further, merging datasets from multiple TTA models leads to additional improvements, suggesting that each model captures distinct acoustic characteristics beneficial to training SC models.

The disclosed techniques demonstrate that TTA-generated datasets serve as effective substitutes or augmentation strategies for SC applications. By leveraging structured and exemplar-based prompt designs and merging outputs from different TTA models, the disclosed method optimizes classification accuracy and dataset utility. Future developments may focus on fine-tuning TTA models to increase generative fidelity, exploring domain adaptation techniques to reduce distribution mismatches, altering prompt structuring methods to maintain consistent inclusion of key attributes, and addressing potential biases introduced by LLM-based prompt generation. By refining these strategies, synthetic datasets may continue evolving as a viable alternative for training robust and scalable SC models.

The disclosed synthetic dataset generation framework may be further utilized to train and refine SC models for various applications. By combining synthetic datasets with real-world data, a deep learning model may be trained to improve generalization across different acoustic environments. The training process may involve feeding both real and synthetic data into a convolutional neural network, such as CNN10, which may be optimized using iterative learning cycles. Model hyperparameters, including learning rate, batch size, and regularization factors, may be adjusted to enhance classification accuracy. Additionally, cross-validation techniques, such as five-fold or ten-fold cross-validation, may be employed to evaluate the model's performance and reduce the risk of overfitting.

Refinement of the trained SC model may involve continuous integration of newly generated synthetic datasets, as well as real-world audio samples collected from deployment environments. As classification errors and misclassifications are identified, new synthetic samples may be generated using structured and exemplar-based prompts to improve the model's ability to distinguish between similar sound categories. For instance, if the model exhibits confusion between acoustically similar categories such as sheep and cows or helicopter and airplane, additional structured prompts incorporating key differentiating characteristics may be used to generate synthetic samples that enhance discrimination between these categories. Furthermore, domain-specific fine-tuning may be performed by training the model on a subset of real and synthetic audio data tailored to a particular application. This approach may be beneficial in environments where sound characteristics vary significantly, such as in manufacturing facilities, urban monitoring systems, or medical settings.

The trained SC model may be deployed across various real-world applications to enhance sound classification capabilities in environments where real-world labeled data is limited. In industrial settings, an SC model trained with synthetic and real-world datasets may be used for fault detection in manufacturing equipment. For example, a factory may integrate an SC model into a predictive maintenance system that continuously monitors acoustic signals from hydraulic presses, CNC machines, and conveyor belts. The model may classify operational sounds and detect abnormalities, such as deviations from normal machine operation indicative of tool wear, bearing failure, or insufficient lubrication. Upon detecting an anomaly, the system may trigger an alert, allowing for timely maintenance interventions that reduce equipment downtime and maintenance costs.

Another application of the trained SC model may involve smart home and security systems. The model may be embedded into home automation devices to classify and respond to specific environmental sounds, such as breaking glass, smoke alarms, or human distress signals. By leveraging synthetic datasets to train the model on diverse variations of these sounds, the system may improve its accuracy in recognizing critical events even in noisy environments. Upon detecting an alert-worthy sound, the system may notify homeowners via a mobile application or activate predefined security measures, such as locking doors or contacting emergency services.

The SC model may also be implemented in healthcare and assistive technology to improve accessibility for individuals with hearing impairments. By deploying the model in wearable devices or smart home systems, it may be used to classify and provide real-time alerts for essential environmental sounds, such as approaching vehicles, doorbells, or spoken commands. These sounds may be translated into visual notifications, haptic feedback, or other assistive signals to help users navigate their surroundings more effectively. Additionally, in clinical environments, the SC model may assist in monitoring patient conditions by classifying respiratory sounds, detecting early signs of distress, or identifying deviations from normal biometric patterns that require medical attention.

The ability to train, refine, and apply SC models using synthetic datasets may significantly reduce the dependency on expensive and labor-intensive real-world data collection. This approach may enhance model adaptability, improve classification accuracy, and facilitate broader deployment across industries where sound classification plays a critical role. By leveraging structured and exemplar-based prompting techniques, synthetic datasets may continue evolving to support new applications, optimize model performance, and address challenges associated with data scarcity, domain adaptation, and dataset bias.

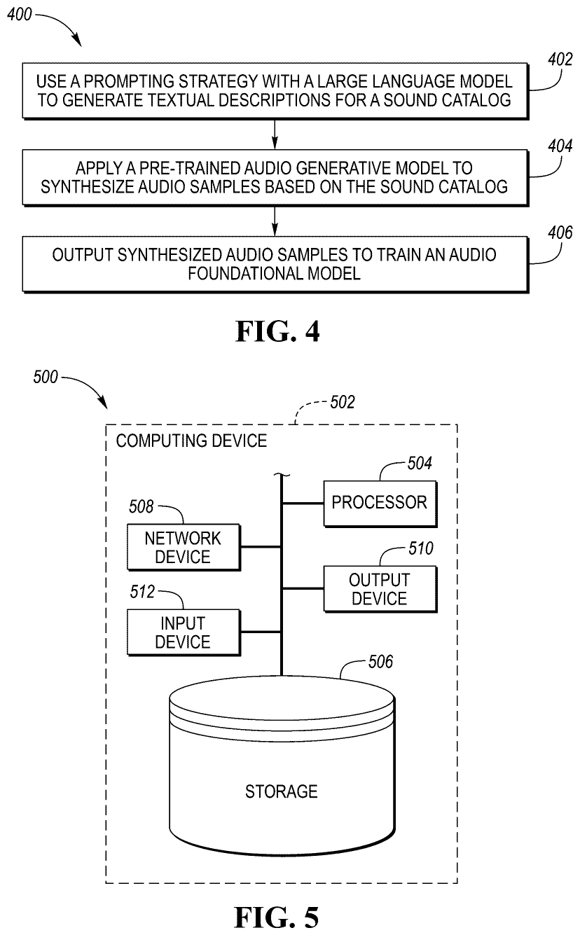

FIG. 4 illustrates a method 400 for generating and utilizing synthetic audio samples to train an audio foundational model. The process begins with applying a prompting strategy 102 using the LLM 104 to generate textual descriptions for a sound catalog. These descriptions are created using different prompting strategies, such as basic, structured, and exemplar-based prompts, to create sample diversity and richness. The basic strategy provides simple labels such as “The sound of a car horn,” while the structured strategy incorporates attributes such as pitch, pattern, intensity, acoustic characteristics, and location to generate detailed descriptions like “A sharp, high-pitched car horn in a busy street.” The exemplar-based strategy utilizes human-annotated datasets, such as the audio captioning dataset 113, to increase linguistic and contextual fidelity.

Once the textual descriptions are generated in step 402, they are processed by a pre-trained audio generative model 106 in step 404 to synthesize corresponding synthetic audio samples 110. This audio generative model 106, which may be an autoregressive model like AG or a latent diffusion model like SA, converts the text prompts into realistic audio waveforms. Adjustments to model parameters, such as temperature or conditioning strength, may enable greater variation and realism in the synthesized sounds.

The final step 406 involves outputting the generated audio samples 110 for training an audio foundational model. These models, which include the audio classification model 112 and the CLAP model 114, utilize the synthetic dataset to improve sound recognition, enhance classification accuracy, and strengthen the alignment between textual and auditory representations. By integrating synthetic audio into training workflows, the method 400 may help to address challenges such as data scarcity, annotation biases, and privacy concerns.

The generated synthetic audio samples 110 may be utilized in various ways beyond dataset augmentation. These samples synthetic audio samples 110 may be used to train a new model from scratch, fine-tune an existing model to improve classification performance, or iteratively refine a deployed model using real-world and synthetic data. In particular, SC models may benefit from multiple rounds of synthetic dataset augmentation, allowing them to adapt to new sound environments, edge cases, or previously underrepresented classes of sounds. Additionally, by incorporating synthetically generated variations of rare or difficult-to-collect sounds, a trained model may be continuously optimized to improve its classification accuracy and generalization across different use cases.

The disclosed method 400 may simplify training of SC models by overcoming challenges associated with dataset scarcity, domain adaptation, and bias reduction. In virtual reality (VR) and augmented reality (AR) environments, for example, synthetic audio samples 110 generated using structured prompts may help create immersive soundscapes for training simulations, gaming, and interactive experiences. In smart security systems, synthetic datasets 150 may be used to improve SC models that classify alarm sounds, breaking glass, or suspicious activities, leading to more reliable automated security responses. Additionally, in scientific research and healthcare, SC models trained using synthetic audio may assist in the early detection of medical conditions, such as classifying respiratory sounds to detect anomalies like wheezing or coughing patterns. By integrating synthetic audio into model training, the method 400 may increase classification accuracy and model generalizability in real-world applications.

FIG. 5 illustrates an example 500 of a computing device 502 for computing device for generating, classifying, and training audio datasets using prompting strategies and audio generative models. The computing device 502 may be configured to process textual prompts, synthesize audio samples, and train audio classification models using generated data. As shown, the computing device 502 includes a processor 504 that is operatively connected to a storage 506, a network device 508, an output device 510, and an input device 512. It should be noted that this is merely an example, and computing devices 502 with more, fewer, or different components may be used.

The processor 504 may include one or more integrated circuits that implement the functionality of a central processing unit (CPU) and/or graphics processing unit (GPU). The processor 504 may execute text processing, prompt augmentation, and audio synthesis using an LLM and an audio generative model. In some examples, the processor 504 is a system on a chip (SoC) that integrates the functionality of the CPU and GPU. The SoC may optionally include other components such as, for example, the storage 506 and the network device 508 into a single integrated device. In other examples, the CPU and GPU are connected to each other via a peripheral connection device such as peripheral component interconnect (PCI) express or another suitable peripheral data connection. In one example, the CPU is a commercially available central processing device that implements an instruction set such as one of the x86, ARM, Power, or microprocessor without interlocked pipeline stage (MIPS) instruction set families.

Regardless of the specifics, during operation the processor 504 executes stored program instructions that are retrieved from the storage 506. The stored program instructions, accordingly, include software that controls the operation of the processors 504 to process prompting strategies, synthesize audio, train classification models, and perform the operations described herein. The processor 504 may execute complex algorithms that may be involved prompt refinement, text-to-audio generation, and alignment with contrastive learning models such as CLAP. The storage 506 may include both non-volatile memory and volatile memory devices. The non-volatile memory includes solid-state memories, such as not and (NAND) flash memory, magnetic and optical storage media, or any other suitable data storage device that retains data when the system is deactivated or loses electrical power. The volatile memory includes static and dynamic random-access memory (RAM) that stores program instructions and data during operation of the system 100 and its audio generation and classification. The network device 508 may facilitate data retrieval and model training by storing and transmitting generated audio samples. The network device 508 may also connect to cloud-based machine learning infrastructures for scalable processing.

The GPU may include hardware and software for display of at least two-dimensional (2D) and optionally 3D graphics to the output device 510. The output device 510 may be configured to present results of the audio generation and classification process, including synthesized waveforms, performance metrics, and dataset statistics. The output device 510 may include a graphical or visual display device, such as an electronic display screen, projector, printer, or any other suitable device that reproduces a graphical display. As another example, the output device 510 may include an audio device, such as a loudspeaker or headphone, allowing real-time playback of generated audio samples. As yet a further example, the output device 510 may include a tactile device, such as a mechanically raiseable device that may, in an example, be configured to display braille or another physical output that may be touched to provide information to a user.

The input device 512 may include any of various devices that enable the computing device 502 to receive control input from users. The input device 512 enables users to interact with the computing device, to configure an active learning process, annotate samples and refine operational parameters of a model based on performance evaluations. Examples of suitable input devices that receive human interface inputs may include keyboards, mice, trackballs, touchscreens, voice input devices, graphics tablets, and the like.

The network devices 508 may each include any of various devices that enable the devices to send and/or receive data from external devices over networks. Examples of suitable network devices 508 include an Ethernet interface, a Wi-Fi transceiver, a cellular transceiver, or a BLUETOOTH or BLE transceiver, UWB transceiver, or other network adapter or peripheral interconnection device that transfers generated audio datasets to machine learning models or external repositories for further evaluation and refinement.

The computing device 502 may be implemented in a variety of real-world scenarios where SC models are deployed for real-time sound classification, anomaly detection, and adaptive learning. For example, in industrial manufacturing, the device 502 may process live audio feeds from factory machinery to detect operational faults, such as tool wear or misalignment, allowing for predictive maintenance and reduced downtime. In smart home automation, the computing device 502 may integrate with IoT devices to classify household sounds, enabling automated responses such as adjusting appliance settings based on detected noise levels or sending security alerts when unusual sounds are identified. Furthermore, in content creation and media production, the computing device 502 may generate synthetic audio samples that enhance voiceover generation, sound effects, or background noise synthesis in films and games. By enabling seamless deployment of trained SC models, the device 502 may enhance real-world applications across industries where audio classification plays a critical role.

In an implementation example, a factory using an automated quality control system for metal stamping operations integrates the disclosed framework within the computing device 502 to enhance anomaly detection in real-time. The system controls a manufacturing machine that includes a hydraulic press used for stamping metal sheets into automotive body components. An array of audio sensors, such as the input device 512, is positioned near the press to capture operational sound data. These sensors transmit captured sounds to the processor 504, where the data is analyzed using an SC model trained with synthetic datasets generated via structured and exemplar-based prompting techniques.

During operation, the computing device 502 continuously monitors audio signals to detect abnormal acoustic patterns. The trained classification model, executed by the processor 504, identifies deviations from normal operating sounds. For instance, if an unusual high-pitched screeching sound indicative of insufficient lubrication is detected, the system flags an anomaly. The output device 510 presents a real-time alert, prompting an automatic adjustment to the lubrication cycle of the manufacturing machine. Additionally, merging synthetic audio samples generated using different TTA models allows the system to adapt across diverse factory environments where machine types and ambient noise conditions vary. The network device 508 facilitates remote monitoring and predictive maintenance by transmitting audio classifications to an external server for further analysis.

Another implementation of the computing device 502 involves training an improved classification model for factory-specific applications. In this scenario, historical machine audio data is used to fine-tune a neural network model, improving its accuracy in detecting anomalies unique to a specific production environment. Initially, raw audio signals are collected from the input device 512, labeled according to different machine states (i.e., normal operation, misalignment, tool wear, or overheating), and stored in the storage 506.

To augment this training data, the factory leverages the disclosed synthetic audio dataset generation framework. Using structured and exemplar-based prompting strategies, additional synthetic samples are created that replicate the sound characteristics of real-world machine malfunctions. These synthetic samples are then merged with real audio data to train the SC model using the processor 504. The training process may involve adjusting model hyperparameters, running multiple training iterations, and evaluating model performance using cross-validation techniques.

Once the model is trained, it is deployed to the computing device 502, where it operates in real-time to classify incoming audio signals from the manufacturing machine. The system continuously refines itself by incorporating new factory data into subsequent training cycles, improving detection accuracy over time. Additionally, the network device 508 enables the trained model to be remotely updated, ensuring adaptability to changes in machine operation, tooling, and production conditions.

The output device 510 may be configured to present results of the audio generation, classification, and training processes, including synthesized waveforms, performance metrics, and dataset statistics. It may include a graphical display screen, a projector, or an audio playback device such as a loudspeaker or headphone. In the factory example, the output device 510 presents alerts related to detected anomalies, enabling operators to take corrective actions. The input device 512 allows operators to provide feedback on system-generated alerts, confirming detected anomalies or dismissing false positives, which can further refine the classification model.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as read-only memory (ROM) devices and information alterably stored on writeable storage media such as floppy disks, magnetic tapes, compact discs (CDs), RAM devices, and other magnetic and optical media. The processes, methods, or algorithms can also be implemented in a software executable object. Alternatively, the processes, methods, or algorithms can be embodied in whole or in part using suitable hardware components, such as application specific integrated circuit (ASIC), field-programmable gate array (FPGA), state machines, controllers or other hardware components or devices, or a combination of hardware, software, and firmware components. These implementations facilitate efficient execution of the disclosed prompting strategies, audio generation methods, and classification model training.

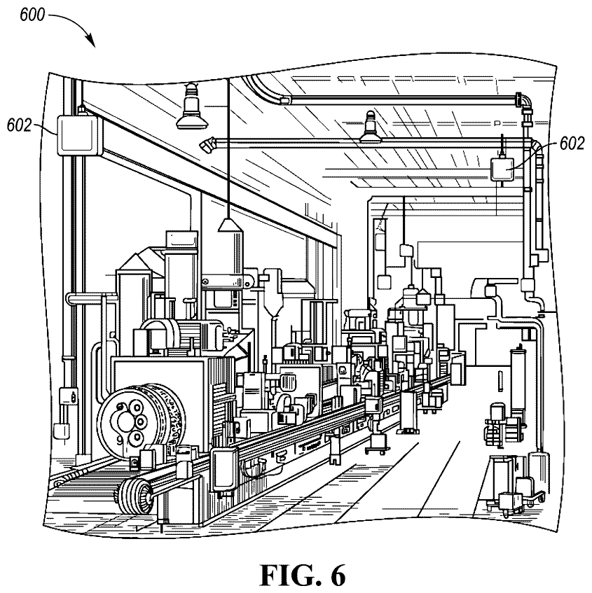

FIG. 6 illustrates an industrial setting 600 where the disclosed synthetic audio generation and classification techniques are applied to monitor equipment performance and detect anomalies. The setting includes a sensor system 602 that integrates multiple sensor types, including audio sensors, vibration sensors, thermal sensors, visual cameras, pressure sensors, and proximity sensors. These sensors capture diverse data streams that serve as inputs for the anomaly detection and classification method 100.

The audio sensors within the sensor system 602 detect operational sounds from machinery, identifying unusual acoustic patterns indicative of mechanical faults. Vibration sensors monitor deviations in normal vibrational behavior, while thermal sensors detect overheating issues. Visual sensors capture physical wear or structural abnormalities that may not be evident through audio or vibration data alone. By leveraging a multi-sensor approach, the system 100 allows for robust data collection, increasing the reliability of anomaly detection.

The collected data undergoes an unsupervised exploration phase, where potential anomalies are identified through clustering and pattern recognition techniques. An anomaly ranking process then prioritizes samples for expert annotation, refining the labeled dataset used to fine-tune the classification models, including the audio classification model 112 and the CLAP model 114. Through this iterative active learning framework, the classification accuracy of the models improves over time, adapting to evolving industrial conditions and operational requirements.

The integration of synthetic audio samples 110 into this framework provides additional benefits. When real-world anomaly data is scarce, synthetic datasets 150 generated using structured and exemplar-based prompts enhance the model's ability to recognize fault conditions. The ability to generate high-quality synthetic anomalies ensures that classification models remain robust across various operational scenarios, ultimately leading to improved equipment monitoring, predictive maintenance, and fault diagnosis in industrial settings.

The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

It must also be noted that, as used in the specification and the appended claims, the singular form “a,” “an,” and “the” comprise plural referents unless the context clearly indicates otherwise. For example, reference to a component in the singular is intended to comprise a plurality of components.

The term “comprising” is synonymous with “including,” “having,” “containing,” or “characterized by.” These terms are inclusive and open-ended and do not exclude additional, unrecited elements or method steps. The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole. The phrase “consisting essentially of” limits the scope of a claim to the specified materials or steps, plus those that do not materially affect the basic and novel characteristic(s) of the claimed subject matter. The term “one or more” means “at least one” and the term “at least one” means “one or more.” The terms “one or more” and “at least one” include “plurality” as a subset.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A method for generating a trained audio foundational model using synthesized audio samples produced by a text-to-audio generative model, comprising:
using a prompting strategy with a large language model to generate textual descriptions for a sound catalog;
applying a pre-trained audio generative model to synthesize audio samples based on the sound catalog;
training an audio foundational model using the outputted synthesized audio samples; and
outputting the trained audio foundational model for use in audio classification or audio analysis.

2. The method of claim 1, wherein the prompting strategy includes generating the textual descriptions within the sound catalog using a sound class descriptor that characterizes audio content based on its acoustic properties or semantic meaning.

3. The method of claim 1, wherein the prompting strategy includes identifying sound attributes and generating the textual descriptions within the sound catalog incorporating identified sound attributes.

4. The method of claim 3, wherein the sound attributes are one or more of pitch, pattern, intensity, acoustic characteristics, and location.

5. The method of claim 1, wherein the prompting strategy includes selecting human-annotated captions from an existing dataset and using selected human-annotated captions as examples for generating additional textual descriptions within the sound catalog.

6. The method of claim 1, further comprising modifying hyperparameters of the pre-trained audio generative model.

7. The method of claim 6, wherein the hyperparameters include one or more of temperature, top-k sampling, top-p sampling, conditioning strength, and noise scale.

8. The method of claim 1, further comprising training a sound classification model using the synthesized audio samples and real-world collected audio data.

9. A system for generating audio samples for training and data augmentation in audio classification and contrastive language-audio pre-training:
a memory configured to store audio datasets and generated captions; and
a processor configured to:
use a few-shot methodology with a large language model to apply a prompting strategy and generate a library of audio clip descriptions;
apply a pre-trained audio generative model to synthesize audio samples based on generated audio clip descriptions; and
output an audio foundational model trained using synthesized audio samples.

10. The system of claim 9, wherein the prompting strategy is a basic prompt strategy that includes generating the audio clip descriptions using a sound class descriptor that characterizes audio content based on its acoustic properties or semantic meaning.

11. The system of claim 9, wherein the prompting strategy is a structured prompting strategy that includes identifying sound attributes and generating the library of audio clip descriptions by incorporating identified attributes.

12. The system of claim 9, wherein the prompting strategy is an exemplar-based prompting strategy that includes selecting human-annotated captions from an existing library of audio clip descriptions and using selected audio clip descriptions as examples for generating additional audio clip descriptions.

13. The system of claim 9, wherein the processor is further configured to generate the output synthesized audio samples by using multiple prompting strategies.

14. The system of claim 9, wherein the processor is further configured to synthesize audio samples by combining audio samples from multiple audio-generative models.

15. A non-transitory computer-readable medium storing instructions that, when executed by one or more hardware computing devices, cause the one or more hardware computing devices to perform operations comprising:
using a few-shot prompting strategy with a large language model to generate a text-based sound catalog;
applying a pre-trained audio generative model to synthesize audio samples based on the text-based sound catalog; and
outputting an optimized audio foundational model trained using synthesized audio samples.

16. The non-transitory computer-readable medium of claim 15, wherein the few-shot prompting strategy includes generating the text-based sound catalog using a sound class descriptor that characterizes audio content based on its acoustic properties or semantic meaning.

17. The non-transitory computer-readable medium of claim 16, wherein the few-shot prompting strategy includes identifying sound attributes and generating the text-based sound catalog by incorporating identified attributes.

18. The non-transitory computer-readable medium of claim 17, wherein the sound attributes are one or more of pitch, pattern, intensity, acoustic characteristics, and location.

19. The non-transitory computer-readable medium of claim 16, wherein the few-shot prompting strategy includes selecting human-annotated captions from an existing text-based sound catalog and using selected captions as examples for generating additional entries to the existing text-based sound catalog.

20. The non-transitory computer-readable medium of claim 15, wherein the pre-trained audio generative model is an autoregressive model or a latent diffusion model.
